(19) United States
(12) Patent Application Publication
(10) Pub. No.: US 2020/0160749 A1
(43) Pub. Date: May 21, 2020

(54) PULLEY SYSTEM FOR USE AS EDUCATIONAL AID AND METHODS

(71) Applicant: The Prophet Corporation, Owatonna, MN (US)

(72) Inventors: Alison Marie Harguth, Owatonna, MN (US); Jason Butler Koberstine, Apple Valley, MN (US)

(21) Appl. No.: 16/193,946

(22) Filed: Nov. 16, 2018

(51) Int. Cl. G09B 23/08; G09B 19/00; F16H 55/36

(52) U.S. Cl. CPC G09B 23/08; F16H 55/36; G09B 19/0069

(57) ABSTRACT

A pulley system educational aid includes a portable standing and self-supporting frame with workstations. Each workstation is sized and positioned for one or more persons to manipulate pulley systems. Each workstation includes at least one pulley bar accessible by one or more persons near the workstation. The pulley arrangement can include a fixed pulley system, a movable pulley system, or a compound pulley system.

### TECHNICAL FIELD

This disclosure concerns a structure and method that can be used as an educational aid regarding pulley systems.

### BACKGROUND

Science, Technology, Engineering, and Mathematics (STEM) education is important. The curriculum integrates the four disciplines into a cohesive learning paradigm based on real-world applications. STEM education helps students understand the world around them, as well as prepare them for good occupations.

A variety of educational aids can be used to help with STEM education. Continuing improvements in ways to educate students with the basics of STEM principles are desirable.

### SUMMARY

An educational aid that helps to teach students about simple machines, in particular pulley systems, is provided.

In general, a pulley system educational aid includes a portable standing and self-supporting frame providing a plurality of workstations. Each workstation is sized and positioned for one or more persons to manipulate pulley systems. Each workstation has at least one pulley bar accessible by one or more persons near the workstation. At least one pulley arrangement is removably attachable to a selected one of the pulley bars in each workstations.

In some example systems, each of the pulley bars has one or more fastening mechanisms secured thereto for releasable attachment to the at least one pulley arrangement.

The fastening mechanism may include one or more hooks secured to the pulley bars.

In many example embodiments, the frame rests on a floor, and each pulley bar is horizontally supported above the floor.

In many example embodiments, there are at least three workstations.

In some example embodiments, there are at least four workstations.

In some examples, the frame includes at least four vertically extending uprights and four pulley bars. Each of the workstations has one of the four bars extending between two of the uprights to form a standing rectangular structure.

In many examples, the frame includes a leg arrangement supporting the standing rectangular structure.

There can includes at least two hooks for each pulley bar, in many embodiments.

In one or more embodiments, at least one weight member is removably attachable to the pulley arrangement.

The at least one weight member can be weight-adjustable.

The at least one weight member may include a container with an interior volume constructed and arranged to hold one or more weight-bearing items.

The weight-bearing items may include bean bags.

In many example embodiments, the container is transparent to allow a visual display of the weight bearing items within the interior volume.

In some example systems, the pulley arrangement includes at least two pulley wheels, at least one weight-adjustable weight member, and the pulley wheels can be removably attachable to the weight-adjustable weight member.

In many example systems, each of the workstations is configurable to demonstrate a fixed pulley system, a movable pulley system, and a compound pulley system. The fixed pulley system includes a first of the pulley wheels secured to the pulley bar, with the weight adjustable weight member secured to a cord. The movable pulley system includes a first of the pulley wheels secured to the weight-adjustable weight member, and the cord secured to the pulley bar. The compound pulley system includes a first of the pulley wheels secured to the pulley bar, a second of the pulley wheels secured to the weight-adjustable weight member, and the cord being secured to the pulley bar.

In many embodiments, the weight-adjustable weight member includes a bucket and a plurality of bean bags.

In example embodiments, there also includes a plurality of carabiners to provide a removable connection between: the pulley bars and the cords; the pulley bars and the pulley wheels; the cords and the weight-adjustable weight members; and the pulley wheels and the weight-adjustable weight members.

In another aspect, a kit for making a pulley system educational aid is provided. The kit includes at least four vertically extending uprights and horizontal pulley bars. One of the pulley bars extends between two of the uprights to form a standing rectangular structure that is portable and self-supporting having four workstations. The kit also includes a plurality of pulleys, each having a pulley wheel and a cord, removably attachable to the pulley bars in each workstation. The kit further includes a plurality of weight-adjustable weight members that can be removably attachable to one of the pulleys at the wheel or the cord.

In some embodiments, the kit includes a leg arrangement supporting the standing rectangular structure.

In some examples, the weight adjusted weight members include a plurality of buckets and a plurality of bean bags.

In one or more embodiments, there is a plurality of carabiners to provide removable connections between the pulley bars and the cords; the pulley bars and the pulley wheels; the cords and the weight-adjustable weight members; and the pulley wheels and the weight-adjustable weight members.

In example arrangements, each of the pulley bars has one or more fastening mechanisms secured thereto for releasable attachment to one of the pulley wheels or cords.

In a further aspect, a method of aiding in the education of pulley systems is provided. The method includes providing a portable standing and self-supporting frame with a plurality of workstations, each workstation having at least one pulley bar accessible by one or more persons. There is a step of providing one or more pulleys, each having a pulley wheel and a cord, removably attachable to the pulley bars in each workstation. There is a step of configuring a first of the workstations to demonstrate a fixed pulley system, in which one of the pulley wheels is secured to the pulley bar of the first workstation and a weight member is secured to the cord. There is a step of configuring a second of the workstations to demonstrate a movable pulley system, in which one of the pulley wheels is secured to a weight member and the cord is secured to the pulley bar of the second workstation. There is a step configuring a third of the workstations to demonstrate a compound pulley system, in which one of the pulley wheels is secured to the pulley bar of the third workstation, another one of the pulley wheels is secured to the weight member; and the cord is secured to the pulley bar of the third workstation.

The method can include adjusting an amount of weight of the weight members in each workstation.

The method can further include configuring the first of the workstations to demonstrate the movable pulley system and the compound system; configuring the second of the workstations to demonstrate the fixed pulley system and the compound pulley system; and configuring the third of the workstations to demonstrate the movable pulley system and the fixed pulley system.

A variety of examples of desirable product features or methods are set forth in part in the description that follows, and in part will be apparent from the description, or may be learned by practicing various aspects of this disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a perspective view of frame used with a pulley system educational aid, constructed in accordance with principles of this disclosure;

FIG. 2 is an exploded, perspective view of the frame of FIG. 1;

FIG. 3 is a perspective view of the pulley system educational aid using the frame of FIG. 1, and demonstrating a fixed pulley system;

FIG. 4 is a perspective view of the pulley system educational aid, similar to FIG. 3, but demonstrating a movable pulley system;

FIG. 5 is a perspective view of the pulley system educational aid, similar to the view of FIGS. 3 and 4, but demonstrating a compound pulley system;

FIG. 6 is an enlarged, fragmented, perspective view of a portion of a pulley bar used with the frame of FIGS. 1 and 2; and

FIG. 7 is an enlarged perspective view of a weight member used with the pulley systems shown in FIGS. 3-5.

### DETAILED DESCRIPTION

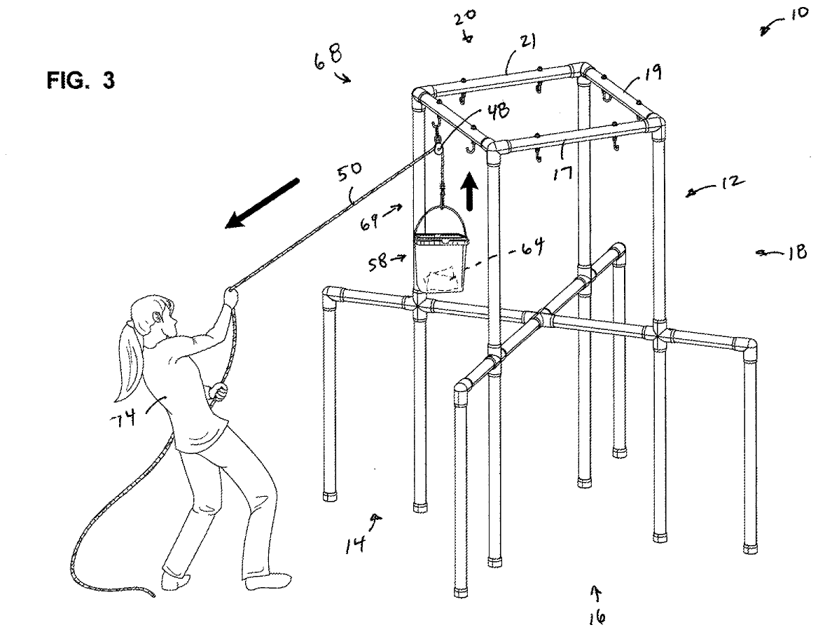

A pulley system educational aid is shown in use in FIGS. 3-5 at 10. The pulley system educational aid 10 can be used to help educate students understand various types of pulley systems and their effects on force needed to lift a load. The educational aid 10 is portable and convenient to set up and move. As such, it is a convenient system for use in classrooms.

The educational aid 10 includes a portable standing and self-supporting frame 12. The frame 12 is typically no taller than 6 feet, preferably no taller than 5 feet, such that all of its parts are reachable and accessible by students in elementary school or above. Of course, there can be variations in the typical heights of the frame 12.

The frame 12 is structured so that it is self-supporting and does not need any other structures to help hold it up. It is organized so that it results in a plurality of workstations, one of which is shown at 14.

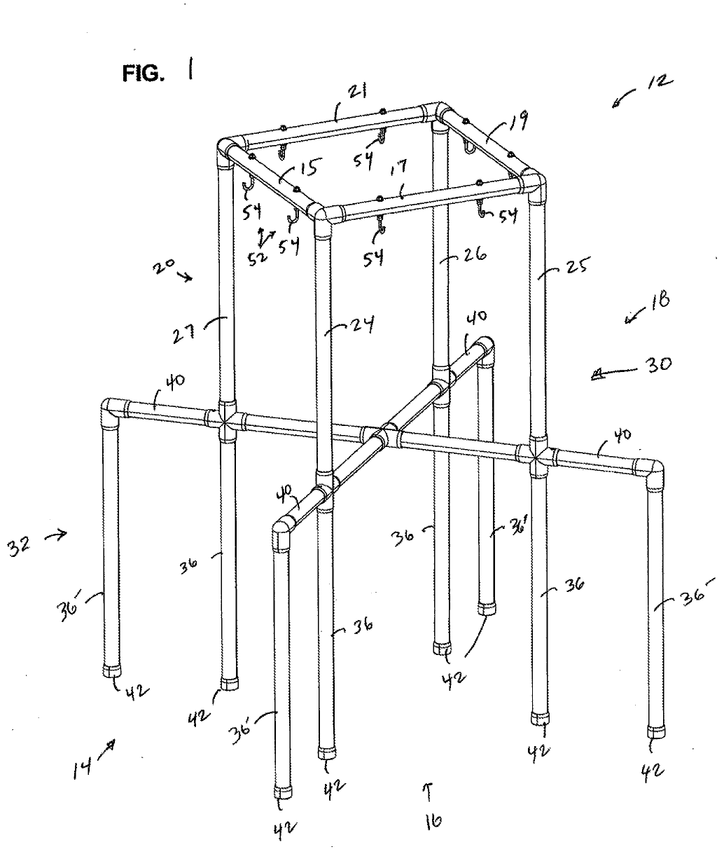

There can be at least three workstations, and in the example shown in FIGS. 1-5, there are four work stations, depicted at 14, 16, 18, and 20. Workstations 14 and 18 are 180° apart, while workstations 16 and 20 are 180° apart. Workstation 16 is between workstations 14 and 18, and workstation 20 is between workstations 14 and 18. Each workstation 14, 16, 18, and 20 is sized and positioned for one or more persons (students) to manipulate pulley systems within the individual workstation. This arrangement is convenient in that each individual workstation 14, 16, 18, and 20 can be set up with a unique pulley arrangement, such that the students can rotate between the workstations 14, 16, 18, 20 to experiment with each pulley arrangement set up at each workstation.

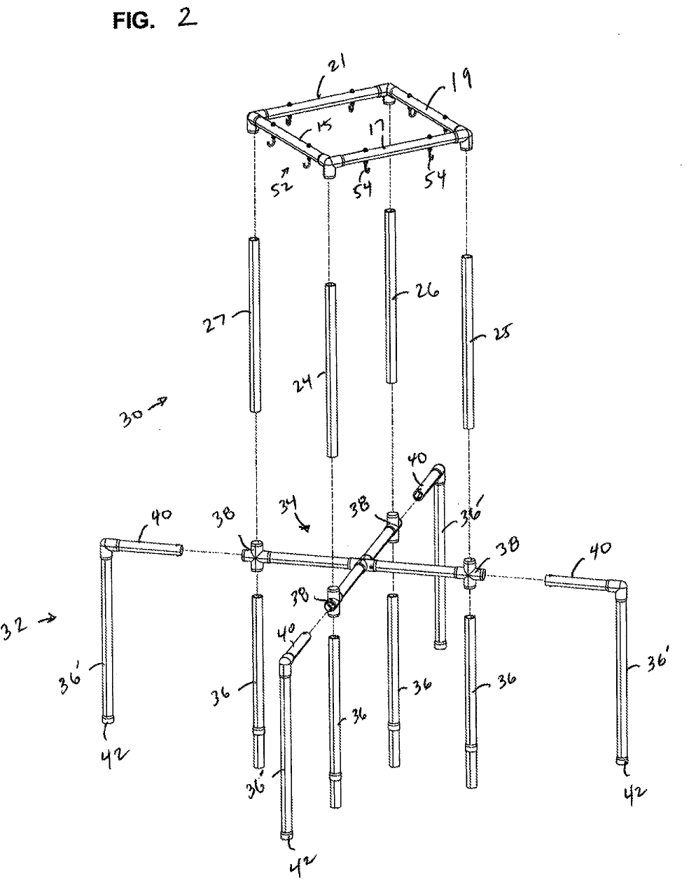

Each workstation 14, 16, 18 and 20 has at least one pulley bar accessible by one or more persons near the respective workstation. In the example shown in FIGS. 1 and 2, workstation 14 has pulley bar 15; workstation 16 has pulley bar 17; workstation 18 has pulley bar 19; and workstation 20 has pulley bar 21.

In many convenient arrangements, each pulley bar 15, 17, 19, and 21 is horizontally supported above the floor or ground surface. However, it is contemplated that in other arrangements, the pulley bars 15, 17, 19, 21 need not be horizontally supported, but could be vertically supported or supported in a variety of other angles.

Many arrangements are possible for making the frame 12. In the arrangement shown in FIGS. 1 and 2, the frame 12 includes at least 4 vertically extending uprights 24, 25, 26, and 27. Each of the workstations 14, 16, 18, and 20 has one of the four pulley bars 15, 17, 19, 21 extending between two of the uprights 24, 25, 26, 27 to form a standing rectangular structure 30. In the embodiment shown, the first workstation 14 has pulley bar 15 extending between uprights 27 and 24. The workstation 16 includes pulley bar 17 extending between uprights 24 and 25. The workstation 18 has pulley bar 19 extending between uprights 25 and 26. The workstation 20 has pulley bar 21 extending between uprights 26 and 27.

The standing rectangular structure 30 could itself rest on the floor or the ground surface. In preferred embodiments, the standing rectangular structure 30 is supported by a leg arrangement 32. The leg arrangement 32 supports the standing structure 30 by providing it with a wider base to allow for a more stable arrangement. In addition, the leg arrangement 32 gives additional vertical height so that the pulley bars 15, 17, 19, 21 are at a level that is within a comfortable range for students between 4 feet and 6 feet tall.

Many embodiments for the leg arrangement 32 are possible. In the example arrangement shown in FIGS. 1 and 2, the leg arrangement 32 has a horizontal cross 34 supported by a plurality of vertically extending legs 36. A plurality of connector tubes 38 allow for convenient assembly of the cross 34 with the legs 36. In the example shown in FIGS. 1 and 2, there are four legs 36 that extend vertically directly below and longitudinally aligned with one of the uprights 24, 25, 26, 27. Additional ones of the legs 36′ are laterally spaced outside of the perimeter area formed by the standing rectangular structure 30 and the legs 36. The legs 36′ are connected to horizontal members 40, which are connected to and longitudinally aligned with the cross pieces 34.

The free ends of the legs 36, 36′ engage the floor or ground. These free ends can have rubber ground-engaging end covers 42. The end covers 42 can help enhance friction between the legs 36, 36′ and contribute to overall stability of the frame 12 to prevent it from slipping or unintended moving across the floor or ground.

As can be seen in FIGS. 1 and 2, the overall height of the leg arrangement 32 is about equal in height to the standing rectangular structure 30, which it is supporting. Many alternatives are possible.

The materials of the frame 12, including the pulley bars 15, 17, 19, 21; the uprights 24, 25, 26, 27; the cross 34; and the legs 36, 36′ can be made from a variety of materials. In the example embodiment, they are made from ABS plastic, for lightweightness (which helps with portability) and strength.

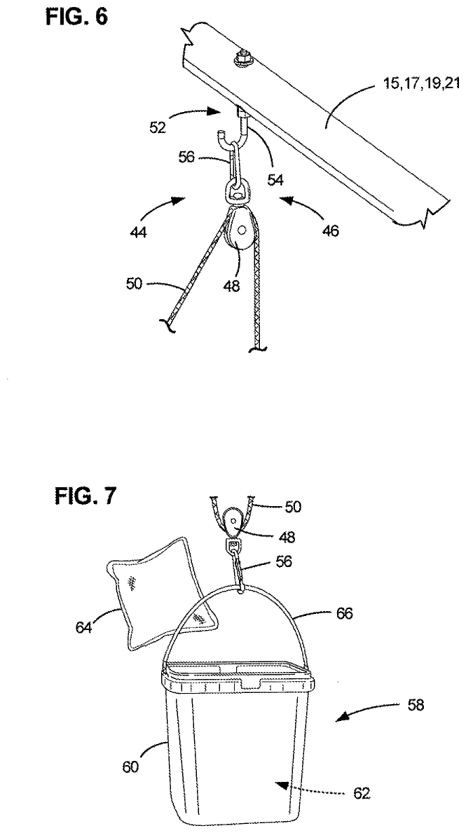

In accordance with principles of this disclosure, the pulley system educational aid 10 further includes at least one pulley arrangement 44 (FIG. 6). The at least one pulley arrangement 44 is removably attachable to a selected one of the pulley bars 15, 17, 19, 21 in each of the workstations 14, 16, 18 and 20.

The pulley arrangement 44 can include a pulley assembly 46. The pulley assembly 46 will include at least one pulley wheel 48 and a cord (rope) 50. As will be explained below, in preferred implementations, the at least one pulley arrangement 44 includes three pulley assemblies.

Preferably, each of the pulley bars 15, 17, 19, 21 has one or more fastening mechanisms 52 secured thereto for releasable attachment to the pulley arrangement 44. While many embodiments are possible, in the example shown, the fastening mechanisms 52 include one or more hooks 54 secured to the pulley bars 15, 17, 19, 21. In the example embodiments shown, there are two hooks 54 secured to each pulley bar 15, 17, 19, 21. Other arrangements can includes more or fewer hooks 54. The hooks 54 allow the pulley wheels 48 to be releasably secured to the pulley bars 15, 17, 19, 21 and can use an optional carabiner, i.e. D-hook, 56 to secure the pulley wheel 48 to the hook 54 (see FIG. 6). Alternatively, the pulley wheel 48 can be secured directly to the hook 54 without using a carabiner 56.

The educational aid 10 further includes at least one weight member 58 (FIG. 7) removably attachable to the cord 50 used with one of the pulley arrangements 44. Many embodiments are possible. Preferably, the weight member 58 is weight-adjustable. By being weight-adjustable, the amount of mass can be changed to allow for the students to experiment with how much weight can be moved using the various types of pulley systems.

While many embodiments are possible, in the example shown in FIG. 7, the weight member 58 is a container 60, such as a bucket, with an interior volume 62 constructed and arranged to hold one or more weight-bearing items.

In the example shown in FIG. 7 the weight-bearing items include one or more bean bags 64. Preferably, the container 60 is transparent to allow a visual display of the bean bags 64 within the interior volume 62.

The bean bags 64 can be differentiated in both size and color to indicate different amounts of mass (weight). This differentiation will allow the students to visualize relative amounts of mass contained within each container 60 by seeing both the size of the bean bags 64 and the color of the bean bags 64. In addition, the students will be able to see the number of bean bags 64 within the container 60.

In FIG. 7, the container 60 can be seen secured to a pulley wheel 48 with carabiner 56. The container 60 includes a handle 66 that is releasably attached to the pulley wheel 48 using the carabiner 56.

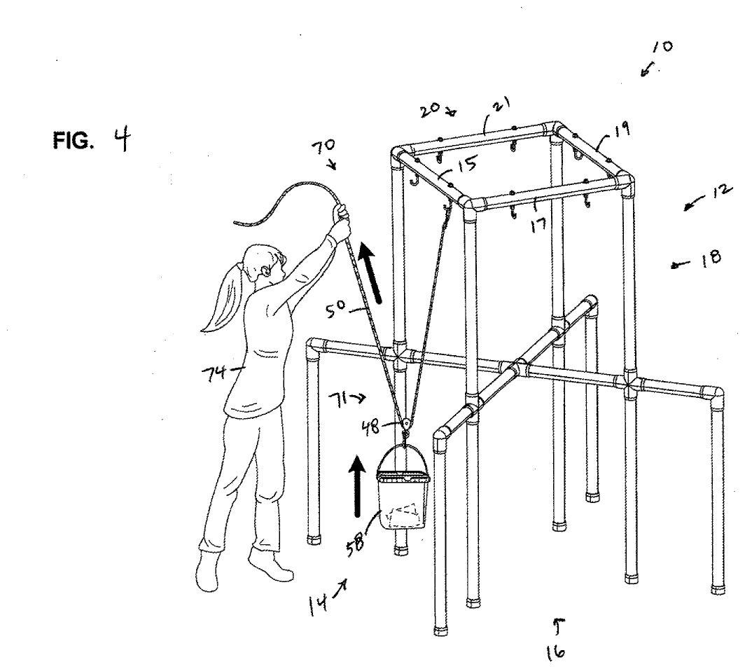

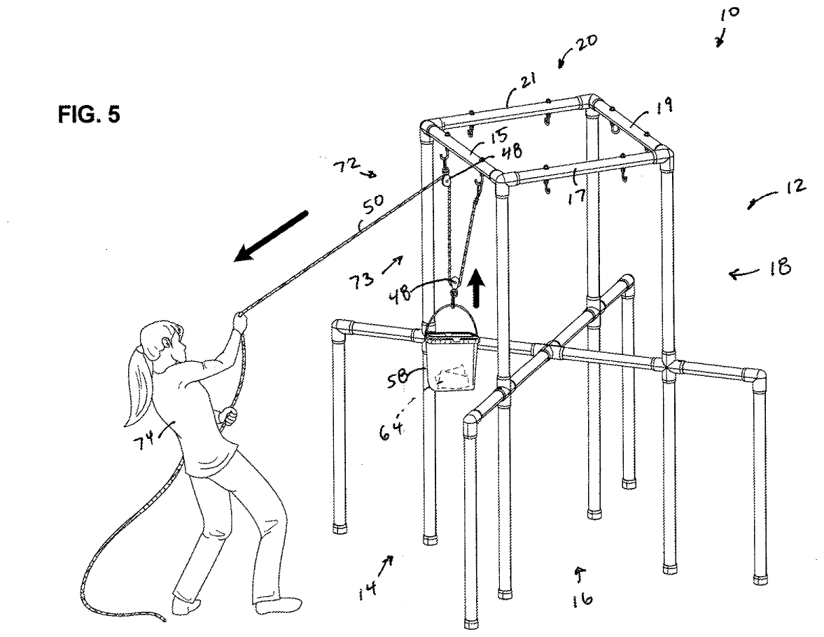

Attention is now directed to FIGS. 3-5. The at least one pulley arrangement 44 includes first pulley assembly 68 (FIG. 3), second pulley 70 (FIG. 4), and third pulley assembly 72 (FIG. 5).

In FIG. 3, the first pulley assembly 68 is a fixed pulley system 69. The fixed pulley system 69 includes pulley wheel 48 secured to the pulley bar 15 and the cord 50 secured to the weight adjustable weight member 58. A person 74 is shown engaging the fixed pulley system 69 by pulling the cord 50, which goes over the pulley wheel 48 and is secured to the weight member 58. The person 74 learns that the fixed pulley system 69 results in a change of direction of force, but has no mechanical advantage.

The second pulley system 70, depicted in FIG. 4, is a movable pulley system 71. The movable pulley system 71 has the pulley wheel 48 secured to the weight adjustable weight member 58 and the cord 50 secured to the pulley bar 15. The person 74 pulls on the cord 50, which is secured to the pulley 48 and the weight member 58. The cord 50 goes from the pulley wheel 48 to the pulley bar 15. With the movable pulley system 71, the student 74 learns that mechanical advantage is achieved and the amount of force required to raise the weight member 58 is cut in half as compared to the fixed pulley system 69.

In FIG. 5, the third pulley assembly 72 is a compound pulley system 73. The compound pulley system 73 has a pulley wheel 48 secured to the pulley bar 15 and a second pulley wheel 48 secured to the weight adjustable weight member 58. The cord 50 is secured to the pulley bar 15 and is threaded through the pulley 48 secured to the weight member 58 and the pulley 48 secured to the pulley bar 15. The student 74 learns that with a compound pulley system 73, more mechanical advantage is achieved relative to the movable pulley system 71 and less force is needed by the student 74 to lift the weight member 58 than the movable pulley system 71 requires.

While FIGS. 3-5 show each of the pulley assemblies 68, 70, 72 used as part of the first workstation 14, it should be understood that all four of the workstations 14, 16, 18, 20 can accommodate each type of pulley assembly 68, 70, 72. In many example uses for the educational aid 10, each workstation 14, 16, 18, 20 will have a uniquely different one of the pulling assemblies 68, 70, 72. The additional workstation can be used for additional experimentation by the student 74 including other compound types of pulley assemblies.

Typically, each of the workstations 14, 16, 18, 20 will have for use with the workstation at least two pulley wheels 48, at least one cord 50, at least one container 60, a plurality of bean bags 64, and a plurality of carabiners 56.

In accordance with principles of this disclosure, a kit can be provided to make the educational aid 10 as discussed above. The kit 10 will includes the materials for assembling the frame 12. These materials can include the vertically extending uprights 24, 25, 26, 27 and four pulley bars 15, 17, 19, 21. The uprights 24-27 and pulley bars 15, 17, 19, 21 can be assembled to form the standing rectangular structure 30 that is portable and self-supporting to result in the four workstations 14, 16, 18, 20. The kit will further include a plurality of pulley wheels 48 and at least one cord 50. Preferably, there will be four cords 50, one for each of the four workstations. The kit can further include a plurality of weight-adjustable members 58, such as buckets that can be removably attached to the pulley wheels 48 or the cords 50. Preferably, there is at least one container 60 and a plurality of bean bags for each of the workstations 14, 16, 18, 20.

The kit can further include the leg arrangement 32 to support the standing structure 30. In preferred arrangements, the kit includes a plurality of carabiners 56 to provide removable connections between the pulley bars 15, 17, 19, 21 and the cords 50; the pulley bars 15, 17, 19, 21 and the pulley wheels 48; the cords 50 and the weight-adjustable weight members 58; and the pulley wheels 48 and the weight-adjustable weight members 58. Preferably, there are at least two carabiners 56 per workstation.

In many preferred arrangements, the kit will have for each of the pulley bars 15, 17, 19, 21 one or more fastening mechanisms 52, such as hooks 54 for releasable attachment to the pulley wheels 48 or cords 50.

The above components can be used as part of a method of aiding in the education of pulley systems. The method includes providing the portable standing and self-supporting frame 12 with the plurality of workstations 14, 16, 18, 20 each having at least one pulley bar 15, 17, 18, 21 accessible by one or more persons 74.

Next, there is a step of providing one or more pulley arrangements 44, each having a pulley wheel 48 and a cord 50 removably attachable to the pulley bars 15, 17, 19, 21 in each of the respective workstations 14, 16, 18, 20.

Next, there is a step of configuring a first of the workstations, such as workstation 14, to demonstrate fixed pulley system 69. Fixed pulley system 69 has pulley wheel 48 secured to the pulley bar 15 and weight member 58 secured to the cord 50.

The method also includes a step of configuring a second of the workstations, such as workstation 16, to demonstrate movable pulley system 71. Movable pulley system 71 includes pulley wheel 48 secured to the weight member 58, and the cord 50 secured to the pulley bar 17.

The method further includes configuring a third of the workstations, such as workstation 18, to demonstrate compound pulley system 73. A first pulley wheel 48 is secured to the pulley bar 19 and a second pulley wheel 48 is secured to the weight member 58. The cord 50 is secured to the pulley bar 19 of the workstation 18.

The method can further include a step of adjusting the amount of weight in the weight member 58. This can be done by adding or subtracting the number of bean bags 64 from within the container 60.

The method can further include changing the types of pulley systems used in each workstation. For example, the first workstation 14 can be configured to demonstrate the movable pulley system 71 and the compound pulley system 73. The second workstation 16 can be changed to demonstrate the fixed pulley system 69 and the compound pulley system 73. The third workstation 18 can be configured to demonstrate the movable pulley system 71 and the fixed pulley system 69. The fourth workstation 20 can be used for additional experimentation with other types of pulley systems or to replicate another one of the fixed pulley system 69, movable pulley system 71, and compound pulley system 73.

The above represents example principles of this disclosure. Many embodiments can be made using these principles.

What is claimed is:

1. A pulley system educational aid; the educational aid comprising:
(a) a portable standing and self-supporting frame providing a plurality of workstations; each workstation being sized and positioned for one or more persons to manipulate pulley systems;
(b) each workstation having at least one pulley bar accessible by one or more persons near the workstation; and
(c) at least one pulley arrangement removably attachable to a selected one of the pulley bars in each workstations.

2. The educational aid of claim 1 wherein each of the pulley bars has one or more fastening mechanisms secured thereto for releasable attachment to the pulley arrangement.

3. The educational aid of claim 2 wherein the fastening mechanisms include one or more hooks secured to the pulley bars.

4. The educational aid of claim 1 wherein the frame rests on a floor, and each pulley bar is horizontally supported above the floor.

5. The educational aid of claim 4 wherein there are at least 3 workstations.

6. The educational aid of claim 4 wherein there are at least 4 workstations.

7. The educational aid of claim 6 wherein the frame includes at least 4 vertically extending uprights and 4 pulley bars; each of the workstations having one of the 4 pulley bars extending between two of the uprights to form a standing rectangular structure.

8. The educational aid of claim 7 wherein the frame includes a leg arrangement supporting the standing rectangular structure.

9. The educational aid of claim 3 wherein there are at least 2 hooks for each pulley bar.

10. The educational aid of claim 1 further comprising at least one weight member removably attachable to the cord used with one of the pulleys.

11. The educational aid of claim 10 wherein the at least one weight member is weight-adjustable.

12. The educational aid of claim 11 wherein the at least one weight member includes a container with an interior volume constructed and arranged to hold one or more weight-bearing items.

13. The educational aid of claim 12 wherein the weight-bearing items include bean-bags.

14. The educational aid of claim 12 wherein the container is transparent to allow a visual display of the weight-bearing items within the interior volume.

15. The educational aid of claim 1 wherein the at least one pulley arrangement includes a first pulley assembly, second pulley assembly, and third pulley assembly; each of the first pulley assembly, second pulley assembly, and third pulley assembly being different from each other and being mounted on the frame.

16. The educational aid of claim 15 wherein:
(a) the first pulley assembly has one pulley wheel secured to the pulley bar of a first of the workstations and a cord secured to a weight adjustable weight member;
(b) the second pulley assembly has one pulley wheel secured to a weight-adjustable weight member and a cord secured to the pulley bar of a second of the workstations; and
(c) the third pulley assembly has one pulley wheels secured to the pulley bar of a third of the workstations, a second of the pulley wheels is secured to a weight-adjustable weight member, and a cord is secured to the pulley bar of the third of the workstations.

17. The educational aid of claim 7 wherein each of the workstations includes:
(a) at least 2 pulley wheels and one cord; and
(b) at least one weight-adjustable weight member;
wherein the pulley wheels are removably attachable to the weight-adjustable weight member.

18. The educational aid of claim 17 wherein each of the workstations is configurable to demonstrate:
(a) a fixed pulley system, in which a first of the pulley wheels is secured to the pulley bar and the weight adjustable weight member is secured to the cord;
(b) a movable pulley system, in which a first of the pulley wheels is secured to the weight-adjustable weight member and the cord is secured to the pulley bar; and
(c) a compound pulley system, in which a first of the pulley wheels is secured to the pulley bar, a second of the pulley wheels is secured to the weight-adjustable weight member; and the cord is secured to the pulley bar.

19. The educational aid of claim 18 wherein the weight adjustable weight member includes a bucket and a plurality of bean bags.

20. The educational aid of claim 18 further comprising a plurality of carabiners to provide removable connections between: the pulley bars and the cords; the pulley bars and the pulley wheels; the cords and the weight-adjustable weight members; and the pulley wheels and the weight-adjustable weight members.

21. A kit for making a pulley system education aid; the kit comprising:
(a) at least 4 vertically extending uprights and 4 horizontal pulley bars; one of the pulley bars extending between two of the uprights to form a standing rectangular structure that is portable and self-supporting having 4 workstations;
(b) a plurality of pulleys, each having a pulley wheel and a cord, removably attachable to the pulley bars in each workstations; and
(c) a plurality of weight-adjustable weight members that can be removably attached to one of the pulleys at the wheel or the cord.

22. The kit of claim 21 further comprising a leg arrangement supporting the standing rectangular structure.

23. The kit of claim 21 wherein the weight adjustable weight members include a plurality of buckets and a plurality of bean bags.

24. The kit of claim 21 further comprising a plurality of carabiners to provide removable connections between: the pulley bars and the cords; the pulley bars and the pulley wheels; the cords and the weight-adjustable weight members; and the pulley wheels and the weight-adjustable weight members.

25. The kit of claim 21 wherein each of the pulley bars has one or more fastening mechanisms secured thereto for releasable attachment to one of the pulley wheels or cords.

26. A method of aiding in the education of pulley systems; the method comprising:
(a) providing a portable standing and self-supporting frame with a plurality of workstations; each workstation having at least one pulley bar accessible by one or more persons;
(b) providing one or more pulleys, each having a pulley wheel and a cord, removably attachable to the pulley bars in each workstations;
(c) configuring a first of the workstations to demonstrate a fixed pulley system, in which one of the pulley wheels is secured to the pulley bar of the first workstation, and a weight member is secured to the cord;
(d) configuring a second of the workstations to demonstrate a movable pulley system, in which one of the pulley wheels is secured to a weight member, and the cord is secured to the pulley bar of the second workstation; and
(c) configuring a third of the workstations to demonstrate a compound pulley system, in which one the pulley wheels is secured to the pulley bar of the third workstation, another one the pulley wheels is secured to the weight member; and the cord is secured to the pulley bar of the third workstation.

27. The method of claim 26 wherein the steps of configuring a first of the workstations, a second of the workstations, and a third of the workstations includes adjusting an amount of weight of the weight member.

28. The method of claim 26 further comprising:
(a) configuring the first of the workstations to demonstrate the movable pulley system and the compound pulley system;
(b) configuring the second of the workstations to demonstrate the fixed pulley system and the compound pulley system; and
(c) configuring the third of the workstations to demonstrate the movable pulley system and the fixed pulley system.
